(19) United States
(12) Patent Application Publication
(10) Pub. No.: US 2020/0134282 A1
(43) Pub. Date: Apr. 30, 2020

(54) IMAGE PROCESSING METHOD, DEVICE, ELECTRONIC APPARATUS AND STORAGE MEDIUM

(71) Applicant: Lenovo (Beijing) Co., Ltd., Beijing (CN)

(72) Inventor: Xingfa TIAN, Beijing (CN)

(21) Appl. No.: 16/729,089

(22) Filed: Dec. 27, 2019

(30) Foreign Application Priority Data
Dec. 29, 2018 (CN) 201811641099.8

(51) Int. Cl. G06K 9/00; G06F 3/041; G06F 3/042

(52) U.S. Cl. CPC G06K 9/0004; G06F 3/042; G06F 3/0412; G06K 9/00053

(57) ABSTRACT

An image processing method includes acquiring an image via an image acquisition assembly arranged under a display screen and including a sensing region corresponding to an input region in a display region of the display screen. The sensing region includes a plurality of sensing units. The method further includes obtaining a reference image representing structural components of the display screen that correspond to the input region and processing the acquired image based on the reference image to obtain a target image.

### CROSS-REFERENCE TO RELATED APPLICATION

This application claims priority to Chinese Patent Application No. 201811641099.8, filed on Dec. 29, 2018, the entire content of which is incorporated herein by reference.

### FIELD OF THE TECHNOLOGY

This application relates to the field of image processing, and more specifically, to an image processing method and apparatus, an electronic device, and a storage medium.

### BACKGROUND

An electronic device has an image acquisition function, for example, fingerprint image acquisition. Currently, during an image acquisition process, in addition to an image-to-be-acquired, noise information is also acquired.

### SUMMARY

In accordance with the disclosure, there is provided an image processing method including acquiring an image via an image acquisition assembly arranged under a display screen and including a sensing region corresponding to an input region in a display region of the display screen. The sensing region includes a plurality of sensing units. The method further includes obtaining a reference image representing structural components of the display screen that correspond to the input region and processing the acquired image based on the reference image to obtain a target image.

Also in accordance with the disclosure, there is provided an electronic device including a display screen, an image acquisition assembly arranged under the display screen, and a processor. The display screen includes a display region including an input region and structural components corresponding to the input region. The image acquisition assembly includes a sensing region corresponding to the input region and including a plurality of sensing units. The processor is configured to acquire an image via the image acquisition assembly, obtain a reference image representing the structural components, and process the acquired image based on the reference image to obtain a target image.

Also in accordance with the disclosure, there is provided a non-transitory computer-readable storage medium storing a computer program that, when executed by a processor, causes the processor to acquire an image via an image acquisition assembly arranged under a display screen and including a sensing region corresponding to an input region in a display region of the display screen. The sensing region includes a plurality of sensing units. The computer program further causes the processor to obtain a reference image representing structural components of the display screen that correspond to the input region and process the acquired image based on the reference image to obtain a target image.

### BRIEF DESCRIPTION OF THE DRAWINGS

In order to more clear illustrate the technical solutions in the embodiments of the present disclosure, the drawings used in the description of the embodiments will be briefly described below. It is obvious that the drawings in the following description are only some embodiments of the present disclosure, and those skilled in the art can obtain other drawings based on these drawings without inventive efforts.

FIG. 1 illustrates a structure diagram of an example under-screen image acquisition apparatus according to an embodiment of the present disclosure;

FIG. 2 illustrates a structure diagram of a display screen according to an embodiment of the present disclosure;

FIG. 3 illustrates a schematic diagram showing light transmission for acquiring fingerprint according to an embodiment of the present disclosure;

FIG. 4A illustrates a schematic diagram of a virtual image corresponding to light-emitting units of a light-emitting layer according to an embodiment of the present disclosure;

FIG. 4B illustrates a fingerprint image according to an embodiment of the present disclosure;

FIG. 4C illustrates a superimposed image generated by superimposing the fingerprint image and the virtual image of the light-emitting layer according to an embodiment of the present disclosure;

FIG. 5 illustrates a schematic diagram showing a transmission path of ambient light according to an embodiment of the present disclosure;

FIG. 6A illustrates an image of external environment according to an embodiment of the present disclosure;

FIG. 6B illustrates a superimposed image generated by superimposing the image of external environment and the virtual image of the light-emitting layer according to an embodiment of the present disclosure;

FIG. 7 illustrates a flow chart of an example image processing method according to an embodiment of the present disclosure; and

FIG. 8 illustrates a structure diagram of an example image processing apparatus according to an embodiment of the present disclosure.

### DESCRIPTION OF EMBODIMENTS

To make clearer of the objectives, technical solutions, and advantages of the present disclosure, the followings further describe the present disclosure in detail with reference to the accompanying drawings. Obviously, the described embodiments are only some but not all of the embodiments of the present disclosure. All other embodiments obtained by a person of ordinary skill in the art based on the disclosed embodiments of the present disclosure without creative efforts are within the scope of the present disclosure.

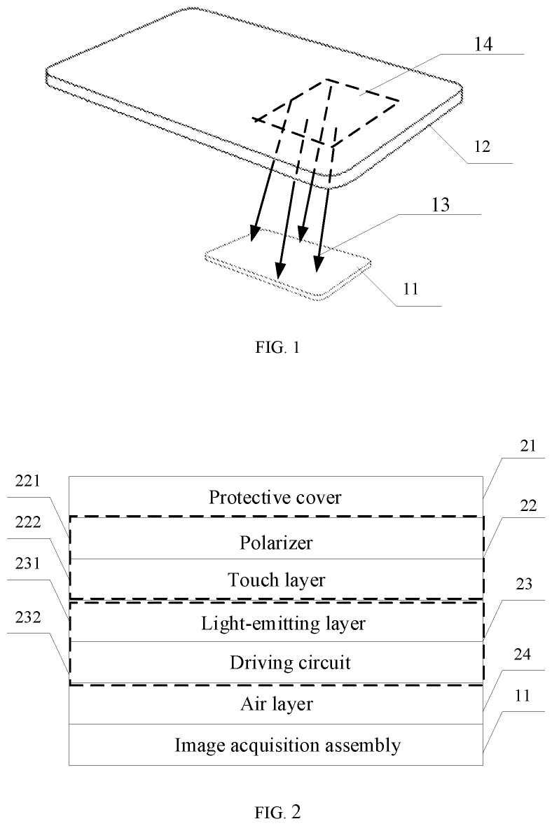

FIG. 1 illustrates a structure diagram of an example under-screen image acquisition apparatus according to an embodiment of the present disclosure. As shown in FIG. 1, the under-screen image acquisition apparatus includes an image acquisition assembly 11 and a display screen 12.

The image acquisition assembly 11 is arranged under the display screen 12. The image acquisition assembly 11 includes a sensing region 13 including a plurality of sensing units. The sensing region 13 of the image acquisition assembly 11 corresponds to an input region 14 in a display region of the display screen 12.

A position of the input region 14 in the display region of the display screen 12 is shown in FIG. 1. The structure shown in FIG. 1 is only one illustrative example. The position and size of the input region 14 in the display region are not limited to the example shown in FIG. 1, and the input region 14 can be located at any position of the display region. Optionally, a specific location of the input region 14 in the display region can be determined based on a relative position of the image acquisition assembly 11 and the display screen 12.

The input region 14 corresponds to the sensing region 13 of the image acquisition assembly 11. That is, light corresponding to the input region 14 (as shown in FIG. 1) can enter the sensing region 13 of the image acquisition assembly 11, such that the image acquisition assembly 11 may acquire an image.

Optionally, the sensing region 13 of the image acquisition assembly 11 may include at least partial region of one side of the image acquisition assembly 11 facing to the display screen 12.

In one embodiment, the under-screen image acquisition apparatus can be applied to any electronic device having a display screen, for example, a smart phone, a personal digital assistant (PDA), a desktop computer, or a laptop computer.

In some embodiments, the image acquisition apparatus can be applied to following application scenarios but is not limited to the following two application scenarios.

In a first application scenario, the under-screen image acquisition apparatus is utilized to acquire a fingerprint image.

A user can place a finger in the input region 14 of the display screen 12. Light-emitting components in the display screen 12 emit light. The light is projected onto a user's finger and is reflected by the user's finger. The reflected light can be projected onto the sensing region 13 of the image acquisition assembly 11, such that the image acquisition assembly 11 can acquire the fingerprint image.

In a second application scenario, the under-screen image acquisition apparatus is utilized to acquire an external environment image.

The ambient light is projected onto the sensing region 13 of the image acquisition assembly 11 through the input region 14 of the display screen 12, such that the image acquisition assembly 11 may acquire the external environment image.

It should be understood that the fingerprint image or the external environment image acquired by the image acquisition assembly includes noise due to the limitation of the structure of the display screen, which is illustrated by taking the structure of the display screen as an example below. FIG. 2 illustrates a structure diagram of a display screen according to an embodiment of the present disclosure. The structure shown in FIG. 2 is only one illustrative example. The structure of the display screen is not limited to the example shown in FIG. 2.

The display screen includes a protective cover 21, an upper glass substrate 22, and a lower glass substrate 23. The upper glass substrate 22 includes a polarizer 221 and a touch layer 222. The lower glass substrate 23 includes a light-emitting layer 231 and a driving circuit 232.

An air layer 24 is arranged between the display screen 12 and the image acquisition assembly 11.

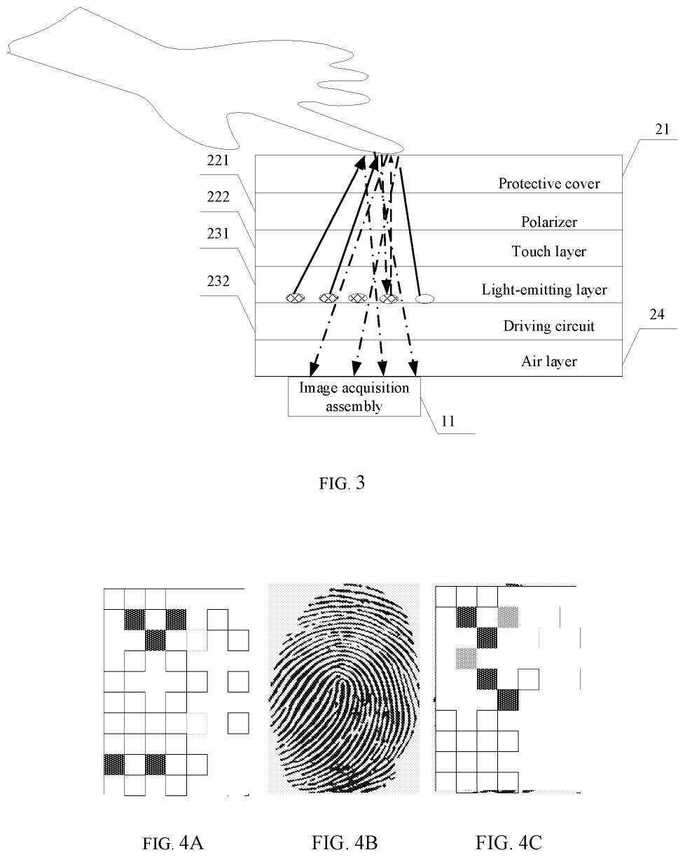

The first application scenario is shown in FIG. 3. FIG. 3 illustrates a schematic diagram showing light transmission for acquiring fingerprint according to an embodiment of the present disclosure.

Optionally, the touch layer 222 may be configured to detect whether there is an operator (such as a user's finger) touching the input region 14 of the display region. If it is detected that there is the operator touching the input region 14 of the display region, a signal can be sent to a processor. After the processor receives the signal, an instruction for instructing the image acquisition assembly to acquire the image can be generated, and the instruction can be sent to the image acquisition assembly. If it is detected that there is no operator touching the input region 14 of the display region, a signal can be sent to the processor. After the processor receives the signal, an instruction for instructing the image acquisition assembly to stop acquiring the image can be generated, and the instruction can be sent to the image acquisition assembly.

The driving circuit 232 may be configured to drive light-emitting units included in the light-emitting layer to emit light. The polarizer 221 may be configured to reduce loss of light emitted by the light-emitting layer, so that the light emitted by the light-emitting layer reaches the protective cover 21 as much as possible.

In some embodiments, the driving circuit 232 can constantly drive the light-emitting units included in the light-emitting layer to emit the light. In some other embodiments, the driving circuit 232 can drive the corresponding light-emitting units included in the light-emitting layer to emit the light when there is the operator touching the input region 14. Optionally, if there is the operator touching the input region 14 of the display region, the processor can generate an instruction for instructing the driving circuit to drive the light-emitting units to emit the light.

In FIG. 3, ellipses represent the light-emitting units of the light-emitting layer, and solid lines represent incident light emitted by the light-emitting units. It should be understood that refraction and/or reflection can occur when the incident light emitted by the light-emitting units passes through the touch layer, the polarizer, and the protective cover. FIG. 3 only shows an approximate light plot and does not show the details of light transmission. Only an approximate light transmission path is shown in FIG. 3.

After the incident light emitted by the light-emitting units of the light-emitting layer is projected onto the user's finger, reflection light can be generated. As shown in FIG. 3, a chain-dotted line represents the reflection light of the incident light. It is understood that reflection or refraction can occur when the reflection light passes through the protective cover, the polarizer, the touch layer, and the light-emitting layer. When the reflection light passes through the air layer, diffuse reflection may occur. FIG. 3 only shows an approximate light plot. Therefore, the details of light transmission is not shown in FIG. 3.

As shown in FIG. 3, certain gaps exist among the light-emitting units of the light-emitting layer. The reflection light can pass through the gaps and be projected onto the sensing region 13 of the image acquisition assembly.

Optionally, as shown in FIG. 3, some reflection light may be projected onto the light-emitting units, and the light-emitting units can reflect the light again. Therefore, the light-emitting units of the light-emitting layer can block a portion of the light from projecting onto the sensing region of the image acquisition assembly.

Because the reflection light passes through the light-emitting units of the light-emitting layer, the light-emitting units may block portion of reflection light. Moreover, the air layer is arranged between the light-emitting layer and the image acquisition assembly. Therefore, diffuse reflection may occur when the reflection light passes through the air layer. As a result, the light-emitting units of the light-emitting layer can form a virtual image of the light-emitting layer in the sensing region of the image acquisition assembly. FIG. 4A illustrates a schematic diagram of a virtual image corresponding to light-emitting units of a light-emitting layer according to an embodiment of the present disclosure. The virtual image may be expressed in many forms. For example, one expression form is shown in FIG. 4A.

The fingerprint image acquired by the image acquisition assembly is a superimposed image generated by superimposing a real fingerprint image and a virtual image of the light-emitting layer. FIG. 4B illustrates a fingerprint image. FIG. 4C illustrates a superimposed image generated by superimposing a fingerprint image and a virtual image of a light-emitting layer. That is, the fingerprint image acquired by the image acquisition assembly is the superimposed image shown in FIG. 4C.

When fingerprint recognition is performed based on the image shown in FIG. 4C, Signal-to-Noise Ratio (SNR) of the fingerprint image is reduced and False Reject Ratio (FRR) of the fingerprint image is increased.

In the first application scenario, a light-emitting component may be any sensor for acquiring light, for example, a complementary metal-oxide-semiconductor (CMOS) sensor.

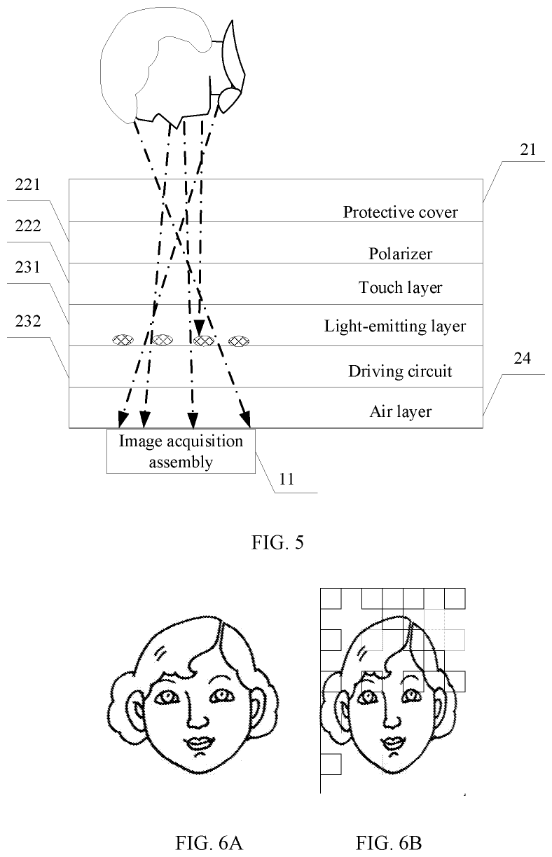

In the second application scenario, FIG. 5 illustrates a general schematic diagram showing a transmission path of ambient light according to an embodiment of the present disclosure. As shown in FIG. 5, ambient light passes through an input region of a display region to a sensing region of an image acquisition assembly. It should be understood that, when the ambient light passes through a protective cover, a polarizer, a touch layer, a light-emitting layer, and an air layer, refraction, reflection or diffuse reflection can occur. FIG. 5 is a general schematic diagram showing a transmission path of the ambient light. Therefore, the detailed process of refraction, reflection or diffuse reflection of the light transmission is not shown in FIG. 5.

As shown in FIG. 5, during the process of the ambient light projecting onto the sensing region of the image acquisition assembly, the ambient light also passes through the light-emitting layer. A virtual image of the light-emitting components included in the light-emitting layer may appear in the sensing region of the image acquisition assembly. The virtual image can be shown in FIG. 4A.

It is assumed that the image of external environment is shown in FIG. 6A. FIG. 6B illustrates a superimposed image generated by superimposing an image of external environment and a virtual image of a light-emitting layer according to an embodiment of the present disclosure. As shown in FIG. 6B, the image acquired by the image acquisition assembly is at least a superimposed image generated by superimposing the external environment image and the virtual image of the light-emitting layer. Thus, the image acquired by the image acquisition assembly has noise, and the clear viewable image of external environment cannot be obtained.

In the second application scenario, optionally, the sensing units included in the image acquisition assembly may be a camera.

In the above embodiments, the light-emitting components included in the light-emitting layer may cause noise in the image acquired by the image acquisition assembly. In some embodiments, the protective cover, the polarizer, and the touch layer are transparent. In some other embodiments, if at least one layer among the protective cover, the polarizer, and the touch layer is opaque, the virtual image may be formed in the sensing region of the image acquisition assembly (i.e., a noise image). In the embodiments of the present application, the components that can form the virtual image in the sensing region of the image acquisition assembly are known as structural components. For example, the structural components may include light-emitting components.

In the image processing method according to an embodiment of the present disclosure, the image formed by the structural components of the display screen that correspond to the input region is used as a reference image. For example, the image shown in FIG. 4A can be used as the reference image. After the image acquisition assembly acquires the image, based on the reference image, the acquired image (as shown in FIG. 4C or FIG. 6B) can be processed to obtain a target image (as shown in FIG. 4B or FIG. 6A).

Therefore, in the image processing method according to an embodiment of the present disclosure, after the image acquisition assembly acquires the image, based on the reference image, the acquired image can be processed to obtain a target image. The target image includes a small amount of the noise image or does not include the noise image. In the first application scenario, Signal-to-Noise Ratio (SNR) of the target image can be increased and False Reject Ratio (FRR) of the target image can be reduced. In the second application scenario, the clear viewable target image can be obtained.

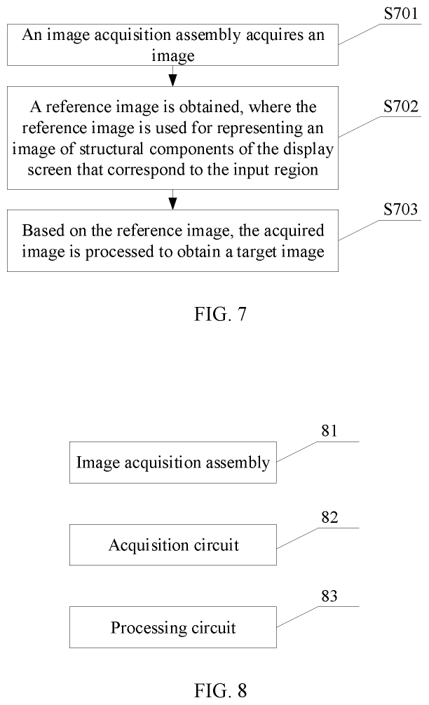

FIG. 7 illustrates a flow chart of an example image processing method according to an embodiment of the present disclosure. As shown in FIG. 7, this method includes the following processes.

At S701: an image acquisition assembly acquires an image, where the image acquisition assembly may include a sensing region including a plurality of sensing units. The image acquisition assembly is arranged under a display screen. The sensing region of the image acquisition assembly corresponds to an input region in a display region of the display screen.

At S702: a reference image is obtained, where the reference image is used for representing an image of structural components of the display screen that correspond to the input region.

In some embodiments, the sensing region of the image acquisition assembly corresponds to a partial region of the display region of the display screen. That is, the input region is the partial region of the display region of the display screen (as shown in FIG. 5).

Only the structural components in the input region of the display screen corresponding to the sensing region of the image acquisition assembly can form a virtual image in the sensing region of the image acquisition assembly. In some embodiments, other region in the display screen that does not correspond to the sensing region of the image acquisition assembly may also include the structural components, but the structural components do not form the virtual image in the sensing region of the image acquisition assembly.

In some embodiments, if the sensing region of the image acquisition assembly corresponds to a whole region of the display region of the display screen, the input region is the display region of the display screen (as shown in FIG. 2).

Only the structural components in the display region of the display screen corresponding to the sensing region of the image acquisition assembly may form the virtual image in the sensing region of the image acquisition assembly.

Therefore, the reference image is used for representing an image of structural components of the display screen that correspond to the input region.

At S703: based on the reference image, the acquired image is processed to obtain a target image.

In some embodiments, the image processing method can be implemented in an electronic device. There are many implementations for the electronic device. In the embodiments of the present application, the following two implementations are provided, but are not limited herein.

In a first implementation, the electronic device may include an image acquisition assembly, a memory, and a processor.

A reference image acquired by the image acquisition assembly can be stored in the memory. After the image acquisition assembly acquires the image, the processor can obtain a target image based on the reference image acquired by the image acquisition assembly.

Optionally, the target image can be stored in the memory.

Optionally, the image acquisition assembly includes a memory space, and the target image can be stored in the memory space of the image acquisition assembly.

In a second implementation, the electronic device may include an image acquisition assembly, where the image acquisition assembly includes a memory space.

The reference image acquired by the image acquisition assembly can be stored in the memory space of the image acquisition assembly. After the image acquisition assembly acquires the image, the image acquisition assembly can process the acquired image based on the reference image to obtain the target image.

Optionally, the target image can be stored in the memory or the memory space included in the image acquisition assembly.

In the image processing method according to an embodiment of the present disclosure, the image is acquired by the image acquisition assembly. The image acquisition assembly may include a sensing region including a plurality of sensing units. The image acquisition assembly is arranged under a display screen. The sensing region of the image acquisition assembly corresponds to an input region in a display region of the display screen. A reference image is obtained, where the reference image is used for representing an image of structural components of the display screen that correspond to the input region. Based on the reference image, the acquired image is processed to obtain a target image. Since the image corresponding to the structural components that can increase the acquired image noise is used as the reference image, and the acquired image is processed based on the reference image, the noise in the acquired image can be reduced, thereby obtaining the target image with little or no noise.

It should be understood that, in order for the image acquisition assembly to acquire the light from the input region in the display region of the display screen (the light can be reflection light of the light emitted by the light-emitting component or incident ambient light), there are certain requirements for arranging a plurality of sensing units of the image acquisition assembly and arranging the structural components of the display screen that correspond to the input region. The modes for arranging a plurality of sensing units of the image acquisition assembly and arranging the structural components of the display screen that correspond to the input region are illustrated in the following, but is not limited to the following two manners.

In a first manner, the arrangement density of the plurality of sensing units of the image acquisition assembly is higher than the arrangement density of the structural components of the display screen that correspond to the input region, so that the light obtained from the input region enters a plurality of sensing units.

Optionally, the light obtained from the input region can enter a plurality of sensing units through gaps among the structural components of the display screen that correspond to the input region.

Because the structural components have poor translucency, the structural components can block a part of the light. As a result, part of the light cannot enter the image acquisition assembly. That is, a partial region of the image acquisition assembly cannot obtain the light. If the region containing the sensing units is located in the partial region that cannot obtain the light in the image acquisition assembly, the sensing units cannot obtain the light. Thus, the image acquisition assembly cannot acquire the image.

In summary, if arrangement density of the plurality of sensing units is higher than arrangement density of the structural components, there are always sensing units located in the region that can obtain the light, such that the image acquisition assembly can acquire the image.

Second manner: a plurality of sensing units of the image acquisition assembly are located in the region that can obtain the light in the image acquisition assembly.

In the second manner, both the arrangement density of the plurality of sensing units and the arrangement density of the structural components corresponding to the input region are not limited. Optionally, the arrangement density of the plurality of sensing units may be lower than the arrangement density of the structural components corresponding to the input region. In some embodiments, the arrangement density of the plurality of sensing units may be higher than the arrangement density of the structural components corresponding to the input region. In some embodiments, the arrangement density of the plurality of sensing units may be equal to the arrangement density of the structural components corresponding to the input region.

In the first application scenario, optionally, the light-emitting units in the display screen corresponding to the input region are always set to be in a status where light is emitted. That is, it is constantly in a light emitting state. Optionally, the light-emitting units in the display screen corresponding to the input region can be lighted when the user's finger covers the input region.

To summarize, when the image acquisition assembly acquires the image, the light-emitting units corresponding to the input region in the display screen are lit up. When the user's finger covers the input region, the light emitted by the light-emitting units is reflected by the user's finger, and the reflected light enters a plurality of sensing units through the gaps among the structural components.

In some embodiments, the display screen includes the touch layer. When the user's finger touches and presses the input region, the touch layer can send information that the input region was touched to the processor. The processor can generate an instruction for lighting up the light-emitting units corresponding to the input region. The instruction is sent to the driving circuit, and the driving circuit can drive the light-emitting units corresponding to the input region to light up.

In a first application scenario, optionally, the image acquisition assembly can be a fingerprint circuit. The image acquisition assembly is configured to acquire a fingerprint image. The acquired fingerprint image can be applied to a plurality of application scenarios, for example, a biometric identification application scenario.

In some embodiments, the image acquired by the image acquisition assembly is a grayscale image. The reference image is a grayscale image. In any of the above-described image processing method embodiments, based on the reference image, the acquired image is processed to obtain the target image. The process may further include: performing reduction on the acquired image and the reference image to filter out grayscale values corresponding to the structural components in the acquired image to obtain the target image.

The pixel value of each pixel in the reference image is between 0-255. For example, if a reference image is represented by

$$[ \begin{matrix}100 & 255 & 100 \\ 255 & 100 & 255 \\ 100 & 255 & 100\end{matrix} ] ,$$

and an image acquired by the image acquisition assembly is represented by

$$[ \begin{matrix}50 & 240 & 150 \\ 200 & 10 & 245 \\ 255 & 60 & 150\end{matrix} ] ,$$

then the target image is represented by absolute differences of the corresponding pixel values in the reference image and the acquired image. That is, the target image is represented by

$$[ \begin{matrix}50 & 15 & 50 \\ 55 & 50 & 10 \\ 155 & 195 & 50\end{matrix} ] .$$

In some embodiments, a grayscale value of a pixel at any point in the target image is an absolute difference of the grayscale values of the corresponding pixels in the acquired image and the reference image.

In the second application scenario, in order for the image acquisition assembly to acquire the clear external environment image, the input region of the display screen is controlled as a transparent status.

In some embodiments, the input region of the display screen is controlled as the transparent status. That is, the input region is controlled as a transparent region. Thus, the virtual image (the virtual image increases the noise of the acquired image) of the input region formed in the sensing region of the image acquisition assembly can be avoided.

In some other embodiments, the input region of the display screen is controlled as the transparent status. That is, the input region has a certain transparency (i.e., incomplete shading), so that the ambient light passes through the input region and the gaps among the structural components to project onto a plurality of sensing units, as shown in FIG. 5.

In a second application scenario, the image acquired by the image acquisition assembly is an RGB (red, green, and blue) image, and the reference image is an RGB image. Alternatively, the image acquired by the image acquisition assembly is a grayscale image, and the reference image is a grayscale image.

For the RGB image, a pixel is represented by three values (R value, G value, B value) that range from 0 to 255.

If the reference image is represented by

$$[ \begin{matrix}( 100 , 100 , 100 ) & ( 155 , 200 , 155 ) & ( 100 , 100 , 100 ) \\ ( 155 , 200 , 150 ) & ( 100 , 100 , 150 ) & ( 155 , 100 , 150 ) \\ ( 100 , 100 , 100 ) & ( 155 , 155 , 155 ) & ( 100 , 100 , 100 )\end{matrix} ] ,$$

and the image acquired by the image acquisition assembly is represented by

$$[ \begin{matrix}( 100 , 200 , 110 ) & ( 255 , 200 , 255 ) & ( 100 , 150 , 100 ) \\ ( 255 , 100 , 250 ) & ( 200 , 100 , 250 ) & ( 255 , 200 , 150 ) \\ ( 100 , 200 , 170 ) & ( 255 , 255 , 255 ) & ( 100 , 190 , 100 )\end{matrix} ] ,$$

then the target image is represented by absolute differences of the corresponding pixel values in the reference image and the acquired image. That is, the target image is represented by following values:

$$[ \begin{matrix}( 0 , 100 , 10 ) & ( 100 , 0 , 100 ) & ( 0 , 50 , 0 ) \\ ( 100 , 100 , 0 ) & ( 100 , 0 , 100 ) & ( 100 , 100 , 0 ) \\ ( 0 , 100 , 70 ) & ( 100 , 100 , 100 ) & ( 0 , 90 , 0 )\end{matrix} ] .$$

In some embodiments, the value of a pixel at any point in the target image is an absolute difference of the pixel values of the corresponding pixels in the acquired image and the reference image.

The process for acquiring the reference image is illustrated below.

In one embodiment of the present application, the reference image includes: color values of the structural components of the display screen that correspond to the input region acquired by the plurality of sensing units when the reflected light of the light emitted by the light-emitting units enters a plurality of sensing units through gaps among the structural components of the display screen that correspond to the input region. The color values can be grayscale values or RGB values.

The embodiment of the present application provides but is not limited to the following manners for obtaining the reference image.

First manner: the under-screen image acquisition apparatus is placed in an environment isolated from ambient light. That is, the ambient light cannot pass through the display screen to the sensing region of the image acquisition assembly. At least the light-emitting components corresponding to the input region are driven to emit the light.

In the first manner, after the light emitted by the light-emitting components is reflected, the reflected light can be projected onto the sensing region of the image acquisition assembly, such that the image acquisition assembly may acquire the reference image.

The first manner is suitable for the first application scenario and the second application scenario.

Second manner: for the acquisition mode of the reference image in the first application scenario, instead of a user's finger, a simulation biological object touches the input region in the display region of the display screen.

In some embodiments, the simulation biological object includes at least one of the following: color of the simulation biological object is human skin color, and material of the simulation biological object is silica gel, gel, or thermoplastic elastomer (TPE).

Optionally, the above-mentioned simulation biological object does not have a fingerprint. That is, the simulation biological object is a smooth simulation biological object without any friction ridge.

Because the simulation biological object touches the input region, the transmission path of light shown in FIG. 3 is also formed.

In some embodiments, the reflectivity of the simulation biological object is identical as the reflectivity of the user's finger. That is, the amount of light reflected by the simulation biological object is identical as the amount of light reflected by the user's finger.

Optionally, the transmission path of light reflected by the simulation biological object is identical as the transmission path of light reflected by the user's finger.

If the amount of light reflected by the simulation biological object is less than the amount of light reflected by the user's finger, and both the reference image and the image acquired by the image acquisition assembly are grayscale images, brightness of the reference image acquired by the image acquisition assembly can be properly increased.

If the amount of light reflected by the simulation biological object is greater than the amount of light reflected by the user's finger, and both the reference image and the image acquired by the image acquisition assembly are grayscale images, brightness of the reference image acquired by the image acquisition assembly can be properly decreased.

A plurality of tests can be performed to obtain a plurality of candidate reference images. A plurality of candidate reference images are processed to obtain the reference image. For example, any pixel value of the reference image is an average value (or a weighted average value) of the corresponding pixel values of the plurality of candidate reference images.

Optionally, if the reference image and the image acquired by the image acquisition assembly are grayscale images, the role of the simulation biological object is to reflect light in the embodiment of the present application.

Optionally, in the fingerprint image acquired by the image acquisition assembly, pixel values of friction ridge are 255 (i.e., white color). Pixel values of the position other than the friction ridge are 0 (i.e., black color). Because the simulation biological object has no friction ridge, the image of the simulation biological object acquired by the image acquisition assembly is a black image. The image acquired by the image acquisition assembly is a superimposed image generated by superimposing the black image and the reference image. Because the pixel value of each pixel of the black image is 0, the superimposed image generated by superimposing the black image and the reference image is the reference image.

Example methods consistent with the disclosure are described above in detail. The methods can be applied to various types of apparatus in the present application. The present disclosure also provides an image processing apparatus, as described in detail below.

FIG. 8 illustrates a structure diagram of an example image processing apparatus according to an embodiment of the present disclosure. As shown in FIG. 8, the image processing apparatus includes an image acquisition assembly 81, an acquisition circuit 82, and a processing circuit 83.

The image acquisition assembly 81 may be configured to acquire an image. The image acquisition assembly 81 may include a sensing region constituted by a plurality of sensing units. The image acquisition assembly is arranged under a display screen. The sensing region of the image acquisition assembly corresponds to an input region of a display region of the display screen.

The acquisition circuit 82 may be configured to obtain a reference image, where the reference image is used for representing an image of structural components of the display screen that correspond to the input region.

The processing circuit 83 may be configured to process the acquired image based on the reference image to obtain a target image.

In some embodiments, arrangement density of the plurality of sensing units of the image acquisition assembly is higher than arrangement density of the structural components of the display screen that correspond to the input region, so that the light obtained from the input region enters a plurality of sensing units.

In some embodiments, the image processing apparatus may further include a driving circuit. The driving circuit may be configured to, if the image acquisition assembly acquires the image, light up light-emitting units corresponding to the input region in the display screen. When a user's finger covers the input region, the light emitted by the light-emitting units is reflected by the finger, and the reflected light enters a plurality of sensing units through the gaps among the structural components.

In some embodiments, the image acquired by the image acquisition assembly is a grayscale image, and the reference image is a grayscale image. The processing circuit 83 includes a first reduction unit. The first reduction unit may be configured to perform reduction for the acquired image and the reference image to filter out gray scale values of the acquired image corresponding to the structural components, thereby obtaining the target image.

In some embodiments, the image processing apparatus may further include a controller. The controller may be configured to, if the image acquisition assembly acquires the image, control the input region of the display screen to be in a transparent status, so that the ambient light passes through the input region and the gaps among the structural components to a plurality of sensing units.

In some embodiments, the image acquired by the image acquisition assembly is an RGB image, and the reference image is also an RGB image. The processing circuit 83 may further include a second reduction unit.

The second reduction unit may be configured to perform reduction for the acquired image and the reference image to filter out RGB values of the acquired image corresponding to the structural components, thereby obtaining the target image.

In some embodiments, the reference image includes a color value corresponding to each pixel acquired by the image acquisition assembly when the reflected light of the structural components corresponding to the input region enters the image acquisition assembly.

The present disclosure also provides an electronic device including an image acquisition assembly, a display screen, and a processor.

The image acquisition assembly may be configured to acquire an image. The image acquisition assembly may include a sensing region constituted by a plurality of sensing units.

The display screen is arranged above the image acquisition assembly, and the sensing region of the image acquisition assembly corresponds to the input region in the display region of the display screen.

The image acquisition assembly or the processor may be configured to obtain a reference image, and based on the reference image, process the acquired image to obtain a target image. The reference image is used for representing an image of structural components of the display screen that correspond to the input region.

The present disclosure also provides a computer-readable storage medium storing a computer program. The computer program, when executed by a processor, causes the processor to perform a method consistent with the disclosure, such as one of the example methods described above.

The electronic device realizes an image acquisition process of the under-screen fingerprint circuit (that is, the fingerprint circuit is located below the display screen.) or an under-screen camera (that is, the camera is located below the display screen). Based on the reference image, each frame of the acquired image is processed (e.g., calibrated), which reduces the impact of the acquired image that includes the image of the structural components of the display screen because the fingerprint circuit or/and the camera is set below the screen.

The respective embodiments in the present specification are described in a progressive manner, and the same or similar parts among the embodiments may refer to each other. For each embodiment, the description focuses on the difference from other embodiments. For embodiments of a device or a system, reference may be made to the related part for the corresponding method embodiments, and the descriptions are omitted.

It is to be noted that, in the embodiments, relationship terms such as first, second and the like are only used to distinguish one entity or operation from another entity or operation, but not necessarily require or imply there's any actual relationship or sequence between these entities or operations. Also, terms “include”, “comprise” or any other variation intend to express non-exclusive containing, thereby a procedure, a method, a product or a device including a series of elements can not only include those elements, but also include other elements which is not listed definitely, or includes elements which is inherent to this procedure, method, product or device. In the case that there's no more limitation, element defined by sentence “including one . . . ” does not preclude the procedure, method, product or device including the element from also having additional same element.

With the description of the implementations above, those skilled in the art may understand that the technology in the embodiments of the present disclosure may be realized by software in combination with necessary general hardware platform, or entirely by hardware. Based on such understanding, the technical solution, or at least the part which contribute to the prior art, in the embodiment of the present disclosure, in essence, may be realized by software product, which may be stored in a storage medium such as a ROM/RAM, a magnetic diskette, an optical disk, etc., and include several instructions which may cause a computer device, such as a PC, a server or a network device etc., to perform the method according to the embodiments, or at least certain parts of the embodiments of the present disclosure.

The implementations of the present disclosure have been described above in detail. The principle and the implementations of the present disclosure are described by way of example. The description of the above embodiments is only to help the understanding of the method and the core of the present disclosure. To those skilled in the art, alternations may occur in terms of the implementation or the application range based on the idea of the present disclosure. The content of the specification should not be construed to limit the present disclosure thereto.

What is claimed is:

1. An image processing method comprising:
acquiring an image via an image acquisition assembly arranged under a display screen and including a sensing region corresponding to an input region in a display region of the display screen, the sensing region including a plurality of sensing units;
obtaining a reference image representing structural components of the display screen that correspond to the input region; and
processing the acquired image based on the reference image to obtain a target image.

2. The method according to claim 1, wherein an arrangement density of the plurality of sensing units is higher than an arrangement density of the structural components.

3. The method according to claim 2, further comprising:
turning on light-emitting units corresponding to the input region to allow the image to be acquired.

4. The method according to claim 3, wherein:
the acquired image and the reference image are grayscale images; and
processing the acquired image based on the reference image to obtain the target image includes performing reduction for the acquired image and the reference image to filter out grayscale values corresponding to the structural components in the acquired image to obtain the target image.

5. The method according to claim 3, wherein the reference image includes color values of the structural components acquired by the plurality of sensing units in response to light emitted by the light-emitting units being reflected by an external object and entering the plurality of sensing units through gaps among the structural components.

6. The method according to claim 2, further comprising:
controlling the input region to be in a transparent status to allow ambient light to pass through the input region and gaps among the structural components to reach the plurality of sensing units.

7. The method according to claim 6, wherein:
the acquired image and the reference image are RGB images; and
processing the acquired image based on the reference image to obtain the target image includes:
performing reduction for the acquired image and the reference image to filter out RGB values corresponding to the structural components to obtain the target image.

8. An electronic device comprising:
a display screen including:
a display region including an input region; and
structural components corresponding to the input region;
an image acquisition assembly arranged under the display screen and including a sensing region corresponding to the input region, the sensing region including a plurality of sensing units; and
a processor configured to:
acquire an image via the image acquisition assembly;
obtain a reference image representing the structural components; and
process the acquired image based on the reference image to obtain a target image.

9. The electronic device according to claim 8, wherein an arrangement density of the plurality of sensing units is higher than an arrangement density of the structural components.

10. The electronic device according to claim 9, wherein the processor is further configured to turn on light-emitting units corresponding to the input region to allow the image to be acquired.

11. The electronic device according to claim 10, wherein:
the acquired image and the reference image are grayscale images; and
the processor is further configured to perform reduction for the acquired image and the reference image to filter out grayscale values corresponding to the structural components in the acquired image to obtain the target image.

12. The electronic device according to claim 10, wherein the reference image includes color values of the structural components acquired by the plurality of sensing units in response to light emitted by the light-emitting units being reflected by an external object and entering the plurality of sensing units through gaps among the structural components.

13. The electronic device according to claim 9, wherein the processor is further configured to control the input region to be in a transparent status to allow ambient light to pass through the input region and gaps among the structural components to reach the plurality of sensing units.

14. The electronic device according to claim 13, wherein:
the acquired image and the reference image are RGB images; and
the processor is further configured to perform reduction for the acquired image and the reference image to filter out RGB values corresponding to the structural components to obtain the target image.

15. A non-transitory computer-readable storage medium storing a computer program that, when executed by a processor, causes the processor to:
acquire an image via an image acquisition assembly arranged under a display screen and including a sensing region corresponding to an input region in a display region of the display screen, the sensing region including a plurality of sensing units;
obtain a reference image representing structural components of the display screen that correspond to the input region; and
process the acquired image based on the reference image to obtain a target image.

16. The storage medium according to claim 15, wherein an arrangement density of the plurality of sensing units is higher than an arrangement density of the structural components.

17. The storage medium according to claim 16, wherein the computer program further causes the processor to turn on light-emitting units corresponding to the input region to allow the image to be acquired.

18. The storage medium according to claim 17, wherein:
the acquired image and the reference image are grayscale images; and
the computer program further causes the processor to perform reduction for the acquired image and the reference image to filter out grayscale values corresponding to the structural components in the acquired image to obtain the target image.

19. The storage medium according to claim 17, wherein the reference image includes color values of the structural components acquired by the plurality of sensing units in response to light emitted by the light-emitting units being reflected by an external object and entering the plurality of sensing units through gaps among the structural components.

20. The storage medium according to claim 16, wherein the computer program further causes the processor to control the input region to be in a transparent status to allow ambient light to pass through the input region and gaps among the structural components to reach the plurality of sensing units.
